(19) United States
(12) Patent Application Publication
(10) Pub. No.: US 2009/0320239 A1
(43) Pub. Date: Dec. 31, 2009

(54) Apparatus for fold hinge assemblies for electronic devices and associated methods

(75) Inventors: Kaisu Marjut Keranen, Salo (FI); Tommi Antero Teuri, Teijo (FI); Mikael Aarne Kontkanen, Ilmarinen (FI); Mikko Antti-Pekka Laaksonen, Angelniemi (FI); Masaaki Inaba, Kanagawa (JP)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 12/215,685

(22) Filed: Jun. 26, 2008

(51) Int. Cl. E05D 11/00

(52) U.S. Cl. 16/223

(57) ABSTRACT

An apparatus comprising a cam contact portion and a body portion, the cam contact portion configured to be in mechanical communication with the body portion, the cam contact portion configured to allow for camming contact with a complementary cam contact portion, the cam contact portion comprising a contact material for providing wear resistance and the body portion comprising a dampening material for providing dampening and mechanical engagement of the apparatus with a fold hinge assembly for an electronic device.

### TECHNICAL FIELD

The present invention relates to the field of apparatus for fold hinge assemblies for electronic devices and associated methods. Certain embodiments of the invention relate to apparatus for portable electronic devices, in particular, so-called hand-portable electronic devices which may be hand-held in use (although they may be placed in a cradle in use). Such hand-portable electronic devices include so-called Personal Digital Assistants (PDAs).

The portable electronic devices of the present invention may provide one or more audio/text/video communication functions (e.g. telecommunication, videocommunication, and/or text transmission (Short Message Service (SMS)/Multimedia Message Service (MMS)/emailing) functions), interactive/non-interactive viewing functions (e.g. web-browsing, navigation, TV/program viewing functions), music recording/playing functions (e.g. MP3 or other format and/or (FM/AM) radio broadcast recording/playing), downloading/sending of data functions, image capture function (e.g. using a (e.g. in-built) digital camera), and gaming functions.

### BACKGROUND

Fold hinges, and fold hinge assemblies, are used commonly in clam shell type devices (e.g. electronic devices which have two parts, rotatably movable from open and closed positions by means of the fold hinge assembly).

Fold hinge assembly can comprise two interfacing camming portions, one attached to one part of the device, the other connected to the other part of the device (either directly or indirectly). One camming portion can be retained against the other by a spring mechanism, e.g. a cam return spring.

The camming portions are generally configured such that a user must urge the device from its closed/open positions (e.g. apply a force to one part to rotatably move it relative to the other). Having been urged past a particular angle of rotation, the camming portions/cam return spring also facilitate ease of opening by providing assistance for the user (e.g. provide impulse). The angle interface of the camming portions dictates the angle through which the user must move one part relative to the other before device is urged from its respective open/closed positions.

Fold hinge assemblies are a key component of electronic devices, and can affect the use-ability of the device, as well as influence a user's perception of the quality of the device. Ideally, they should be able to provide satisfying/effective user actuation over a long lifespan.

The listing or discussion of a prior-published document or any background in this specification should not necessarily be taken as an acknowledgement that the document or background is part of the state of the art or is common general knowledge. One or more aspects/embodiments of the present invention may or may not address one or more of the background issues.

### SUMMARY

In a first aspect, there is provided an apparatus comprising a cam contact portion and a body portion, the cam contact portion configured to be in mechanical communication with the body portion, the cam contact portion configured to allow for camming contact with a complementary cam contact portion, the cam contact portion comprising a contact material for providing wear resistance and the body portion comprising a dampening material for providing dampening and mechanical engagement of the apparatus with a fold hinge assembly for an electronic device.

The contact material may be a metallic material, such as steel, aluminium, tungsten, etc. The contact material may be a metal injected mould.

The dampening material may be a plastic material, such as a polyvinylchloride (PVC), polyaryletheretherketone (PEEK), polyoxymethylene, (POM), polycarbonate (PC), polyamide (PA), polypropylene (PP), etc. The dampening material may a material with a particular coefficient of static/dynamic friction, such as low coefficient, e.g. polytetrafluoroethene (PTFE).

The body portion may comprise a body engagement element. The body engagement element may be configured to engage with a complementary element of the fold hinge assembly (e.g. configured, in use, to make mechanical touching contact with the fold hinge assembly).

The body engagement element of the body portion may be configured for engagement with a complementary recess/cut-out of a housing for a fold hinge assembly. The recess/cut-out of the housing may act as a guide recess/cut-out.

The body engagement element may be configured, when in use with a guide recess/cut-out, to allow movement of the cam portion in a linear direction, which may be parallel to the major axis of a housing. The body engagement element may act, when in use with a guide recess/cut-out, to inhibit/reduce rotation of the body portion relative to the housing.

The body engagement element may be configured, when in use with a guide recess/cut-out, to inhibit/reduce rotation of the cam contact portion relative to the housing.

The cam contact portion may comprise a cam engagement element, configured, in use, to be aligned with the body engagement element. The cam engagement element may be configured to sit within the complementary recess/cut-out of a housing (e.g. to allow for a clearance between the sides of the cam engagement element and a recess/cut-out of a housing.

A body engagement element may be roughly 5 mm wide. The body engagement elements may be roughly 3 mm, 2 mm, 1 mm, or 0.5 mm wide, or any number therebetween. The corresponding cam engagement element may be not as wide as the body engagement elements. For example, the body engagement elements may be 2 mm, 1 mm, 0.75 mm, 0.5 mm, 0.25 mm, or 0.1 mm narrower, or any number therebeween.

The cam engagement element may be configured, when in use with a guide recess/cut-out of a housing, to inhibit/reduce rotation of the cam contact portion relative to the housing.

Either, or both of the cam engagement element and the body engagement element may be provided by a recess/cut-out portion. Either or both may be configured to co-operate with a protruding element of a housing. Either or both may be provided by a combination of recesses/cut-outs and engagement elements.

The apparatus may further comprise a housing. The housing may be configured to allow for transfer a rotation camming action of the cam contact portion. The housing may be configured to transfer the rotational camming action of the cam contact portion to a part for a device, such as an electronic device (e.g. to transfer the rotational camming action of the cam contact portion to a one/both of the foldable parts of a electronic device, for example, user interface, display, etc. so as to open/close such a device).

The housing may have an inner width/diameter of roughly 4.08 mm (e.g. 3.9 mm, 4.0 mm, 4.05 mm, 4.1 mm, 4.2 mm, or any number therebetween). The cam contact portion/body portion may have a corresponding outer width/diameter of roughly 4.0 mm (e.g. 3.8 mm, 3.9 mm, 4.0 mm, 4.02 mm, 4.12 mm, or any number therebetween).

A cam return spring may be configured such that the cam contact surface is retained against a complementary cam contact surface during rotation of the cam contact portion. The cam return spring/cam contact portion may be configured such that, after a particular angle of rotation, the cam return spring provides for an impulse force. The impulse force may allow for assisted opening/closing of a device comprising a fold hinge assembly.

The housing may comprise a recess/cut-out (e.g. a guide recess/cut-out) for the body/cam engagement element, or comprise a protrusion element for a complementary recess/cut-out on the cam contact protrusion/body portion, or both (e.g. combination of protrusion elements and recesses/cut-outs). The recess/cut-out/protrusion element may be a guide portion, which may be configured to allow the movement of the cam contact portion in a linear direction, parallel to the major axis of the housing.

The body engagement element may be configured to interfere (e.g. interfere so as to make mechanical touching contact) with the recess/cut-out during rotational movement of the housing. The body engagement element may be configured such that it interferes so as to allow for linear movement of the cam contact portion relative to the major axis of the housing, but not to allow for rotational movement of the cam contact portion/body portion relative to the housing.

The body portion may be configured to engage with a housing for the apparatus. That is the body portion may be provided with no body engagement element. The body portion may be provided by a particular (irregular) configuration (e.g. a hexagonal cross-section), which engages with a complementary housing. Such an arrangement may provide for linear movement of the cam contact portion relative to the major axis of the housing, but not to allow for rotational movement of the cam contact portion/body portion relative to the housing.

The body portion may be configured to provide an interference engagement with a housing for the apparatus. The cam contact portion may be provided such that no interference occurs between the cam contact portion and a housing for the apparatus.

The body portion of an apparatus may be configured for interference engagement with a fold hinge assembly for an electronic device (e.g. the body portion of an apparatus which is not configured to be linearly moved during use). The body portion may be configured for interference engagement with a retaining element of a fold hinge assembly. The retaining element may be provided with a shaft (e.g. a shaft around the main axis of which rotation occurs) of a fold hinge assembly. The retaining element may be provided at one end of the shaft.

The body portion may be comprised with a part for an electronic device (e.g. comprised with a part of the casing of the device, or a part which comprises a display, keypad, etc.).

According to a second aspect of the present invention there is provided a module comprising at least one apparatus according to the first aspect (e.g. two apparatus according to any features of the first aspect). The module may further comprise at least one of: a shaft; a cam return spring; a housing.

According to a third aspect of the present invention, there is provided a fold hinge for an electronic device comprising a module according to the second aspect.

According to a fourth aspect there is provided a module for an electronic device comprising a fold hinge according to the third aspect.

The module may further comprise a rotatable part for an electronic device (e.g. a part for a display, keypad, e.g. a rotatable casing)

According to a fifth aspect there is provided an electronic device comprising a module according to the fourth aspect. The electronic device may be one of: mobile telephone; media device; multimedia device; Personal Digital Assistant, portable computer; gaming device.

According to a sixth aspect there is provided a means for an apparatus comprising a means for a cam contact and a means for a body, the means for cam contact configured to be in mechanical communication with the means for a body, the means for cam contact configured to allow for camming contact with a complementary means for cam contact, the means for cam contact comprising a means for a contact material for providing wear resistance and the means for a body comprising a means for a dampening material for providing dampening and mechanical engagement of the means for an apparatus with a means for a fold hinge assembly for an electronic device.

According to a seventh aspect there is provided a method comprising providing an apparatus comprising a cam contact portion and a body portion, providing the cam contact portion such that it is configured to be in mechanical communication with the body portion, configuring the cam contact portion to allow for camming contact with a complementary cam contact portion, providing the cam contact portion with a contact material for providing wear resistance and providing the body portion with a dampening material for providing dampening and mechanical engagement of the apparatus with a fold hinge assembly, the method for providing an apparatus for a fold hinge assembly for an electronic device.

According to a seventh aspect there is provided use of an apparatus/module/device/means for an apparatus according any of the first, second, third, fourth, fifth, or sixth aspects.

According to a seventh aspect there is provided an apparatus comprising a cam contact portion and a body portion, the cam contact portion configured to be in mechanical communication with the body portion, the cam contact portion configured to allow for camming contact with a complementary cam contact portion, the cam contact portion comprising a metallic contact material for providing wear resistance and the body portion comprising a plastic dampening material for providing dampening and mechanical engagement of the apparatus with a fold hinge assembly for an electronic device.

The present invention includes one or more corresponding aspects, embodiments or features in isolation or in various combinations whether or not specifically stated (including claimed) in that combination or in isolation. Corresponding means for performing one or more of the discussed functions are also within the present disclosure.

The above summary is intended to be merely exemplary and non-limiting.

### BRIEF DESCRIPTION OF THE FIGURES

A description is now given, by way of example only, with reference to the accompanying drawings, in which:

FIG. 1 shows an embodiment of apparatus for a fold hinge assembly for an electronic device;

FIG. 2 shows a fold hinge assembly for an electronic device, comprising an apparatus as in FIG. 1;

FIG. 3 shows a part of an electronic device, an exemplary clam-shell cellular telephone, and an exemplary simplified representation of a clam-shell cellular telephone comprising a fold hinge;

FIG. 4 shows a cross-section of a fold hinge assembly; and

FIG. 5 shows a flowchart of a method of providing an apparatus for a fold hinge assembly for an electronic device.

### DESCRIPTION OF SPECIFIC EMBODIMENTS

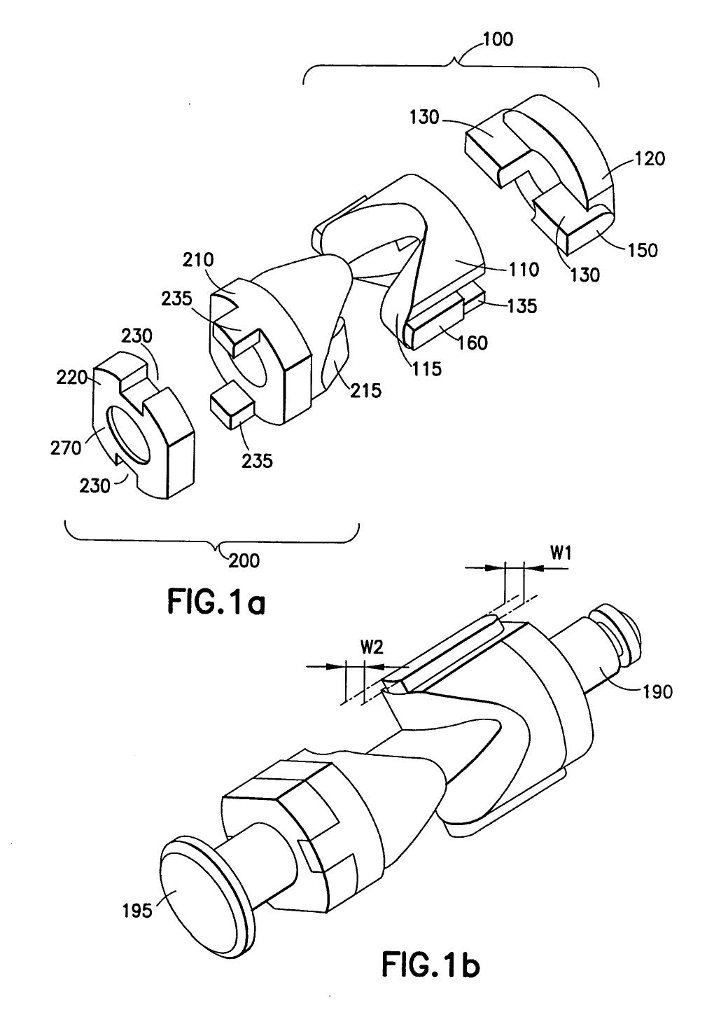

FIG. 1a shows an exploded view of apparatus 100 for a fold hinge assembly for an electronic device (e.g. for a fold hinge for a clam-shell type device, such as a clam shell mobile telephone). The apparatus 100 comprises a cam contact portion 110 and a body portion 120.

The cam contact portion 110 is provided with a camming surface region 115, which is configured to allow for camming contact with a complementary cam contact portion (e.g. a further surface which is configured to work with the cam contact portion 110).

Both the body portion 120, and the cam contact portion 110 are configured for mechanical communication with one another, which in the present embodiment is direct mechanical communication by use of attachment regions 130, 135. The attachment regions 130, 135 are configured such that, in use, there is provided limited relative movement (e.g. no linear, rotation relative movement) between the cam contact portion 110 and the body portion 120.

In the present embodiment both the cam contact portion 110 and the body portion 120 of the apparatus 100 are configured such that they may be provided on a shaft 190 (as shown in FIG. 1b) of a fold hinge assembly as will be described in further detail below. Here, each are toroidal, but in alternative embodiments that need not be the case, and each may be any other shape (e.g. portion of a toroid, etc.).

In the present embodiment the body portion 120 is further provided with body engagement elements 150. Here the body engagement elements 150 extend radially from the body portion 120, and are configured to engage with a recess/cut-out portion (e.g. a guide recess/cut-out portion) of a housing for a fold hinge assembly, as will be further described. The cam contact portion 110 comprises cam engagement elements 160, which in this embodiment are configured to be aligned with the body engagement element 150 when the body portion 120 and cam contact portion 110 are in mechanical communication (as shown in FIG. 1b). Here the width W1 of the body engagement element is larger then the width W2 of the cam engagement element (e.g. 0.1 mm wider).

FIG. 1a also shows an exploded view of a further apparatus 200 for a fold hinge assembly for an electronic device. The apparatus 200 comprises a cam contact portion 210 and a body portion 220, similar to that described above. The apparatus 200 comprises a camming surface region 215 and attachment elements 230, 235 in a similar manner. Here, the apparatus 200 is provided with an engagement surface 270, configured to engage with a retaining element 195 of a shaft 190 for a fold hinge assembly.

In this embodiment, each cam contact portion 110, 210 is provided by a metallic material, such as steel, while the body portions 120, 220 are provided by a plastic material, such as polyvinylchloride (PVC), polytetrafluoroethene (PTFE), polyaryletheretherketone (PEEK), polyoxymethylene, (POM).

While in this embodiment the body portions 120, 220 and the cam contact portions 110, 210 are detailed as distinct connectable portions, in other embodiments they may be provided as one portion (e.g. a single moulded portion).

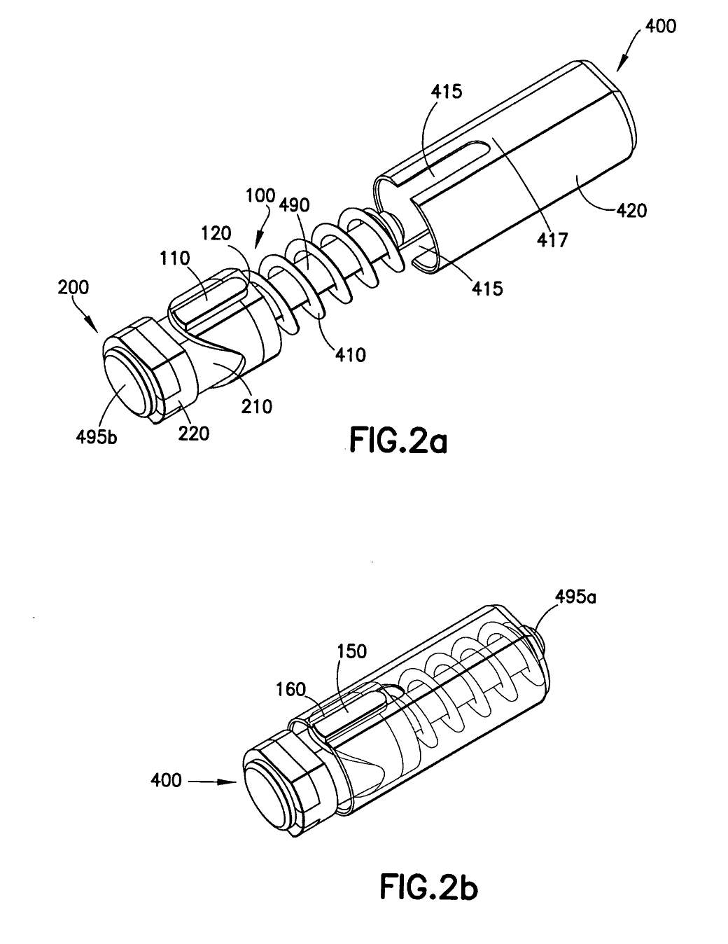

FIG. 2a shows an exploded view of a fold hinge assembly 400 comprising apparatus 100, 200 (first apparatus 100, and second apparatus 200), with respective cam contact portions 110, 210 and body portions 120, 220. The assembly 400 further comprises a shaft 490 (comprising an upper and lower retainer 495a, 495b; one retainer 495a, 495b at each end), a cam return spring 410 and a housing 420.

The cam return spring 410 is configured between the lower retainer 495a and the base portion 120 of the first apparatus 100. The first 100 and second 200 apparatus are configured such that respective camming surface regions 115, 215 can contact. The engagement surface 270 of the base portion 220 of the second apparatus 200 is configured to be retained by the upper retainer 495b.

In the present embodiment the housing 420 is configured to provide cover for cam return spring 410 and at least a portion the first apparatus 100, and in this example is provided with cut-outs 415, configured to receive the body/cam engagement elements 150, 160 (e.g. guide cut-outs to allow for linear translation of the engagement elements 150, 160, relative to the major axis of the housing).

The cut-outs 415 and body engagement elements are configured such that the side regions of the body engagement elements 150 engage (e.g. provide an interference engagement) with the housing 420. The cut-outs 415 are configured so as to allow for linear movement as discussed, but to substantially inhibit rotational movement of the body engagement elements 150 relative to the housing 420. In the present embodiment, the body engagement elements 150 are configured to move both linearly with respect to the major axis of the housing, as well as radially with respect to the housing 420.

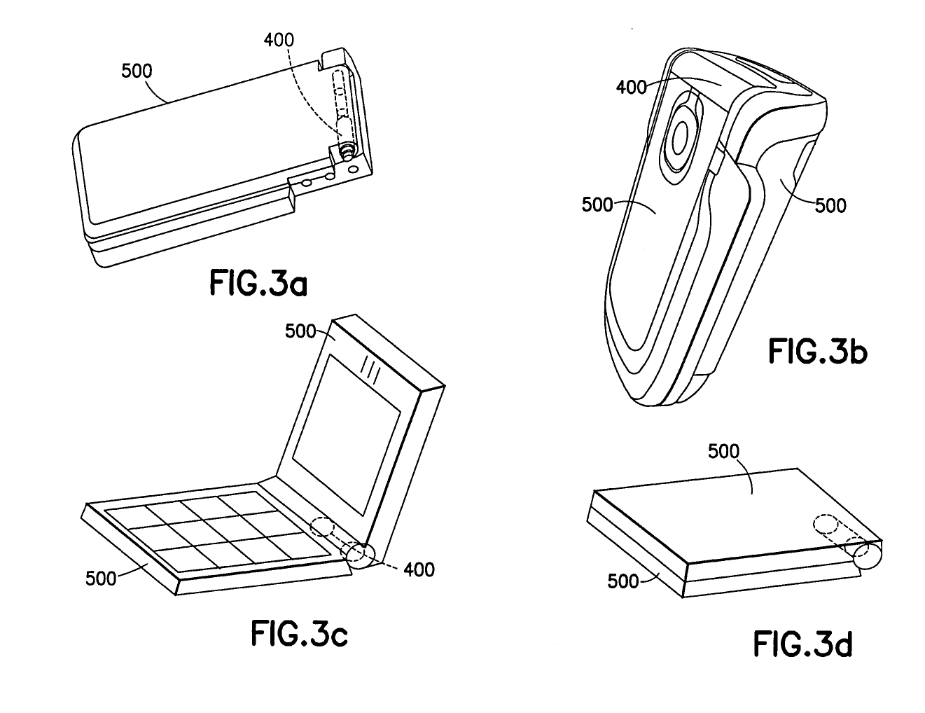

FIG. 2b shows a consolidated fold hinge assembly 400. FIG. 3a shows a part 500 of an electronic device (e.g. a portion of casing) comprising the fold hinge assembly 400 of FIG. 2. FIG. 3b shows an exemplary clam-shell cellular telephone. FIG. 3c shows a simplified representation of an exemplary clam-shell electronic device comprising a fold hinge assembly 400 in an open configuration. Here, the electronic device is shown as a cellular telephone. However, it will readily be appreciated that the hinge assembly 400 may be provided with any other portable electronic devices (e.g. multimedia devices, gaming devices, etc.) FIG. 3d shows the simplified representation of the exemplary clam-shell electronic device in a closed configuration.

In use, the first apparatus 100, via the housing 420, is in mechanical communication with a first part of a folding electronic device (e.g. connected to one part of a clam shell mobile telephone), while the second apparatus 200 is in mechanical communication with a second part of the folding electronic apparatus (e.g. connected to the second part of a clam shell mobile telephone).

When the first apparatus 100, via the housing 420, is rotated relative to the second apparatus 200, the camming surface regions 115, 215 of the respective cam contact portions 110, 210 are configured to engage in order to urge the first apparatus 100 against the cam return spring 410, providing linear displacement of the first apparatus along the shaft 490. After a particular angle of rotation, the cam contact portions 110, 210 are configured such that the cam return spring 410 is able to return the energy so as to urge the first apparatus 100 back along the shaft 490 (e.g. in a reciprocal movement). The cut-outs 415, and respective engagement elements 150, 160 provide that there is no (or limited) rotation of the first apparatus 100 relative to the housing.

This provides that a user of a device, comprising a fold hinge assembly 400 may urge the device partially open/closed, and then (by use of the cam return spring) have the fold hinge assembly assist with the remaining opening/closing. The apparatus, 100, 200, or fold hinge assembly 400, or device are further such configured that the device is restricted from opening beyond a particular angle (e.g. 160 degrees).

The provision of cam contact portions 110, 210 (and respective camming surfaces 115, 215) by a metallic material, allows for the respective cam profiles (cam profile of the first apparatus 100, and follower profile of the second apparatus 200) to provide a small angle, but large force, which a user must rotate/impart on a part 500 of the device before assisted opening/closing is provided. The provision of cam contact portions 110, 210 (and respective camming surfaces 115, 215) by a metallic material, allows for wear of the cam contact portion to be improved with respect to material which readily ablates.

In addition, as the body engagement elements 150 of the first apparatus 100 engage with the housing (via the cut-outs 415, and/or the end 417 of the cut-outs 415), and being made of a dampening material (such as plastic as described), unpleasant noise (such as the striking of the engagement elements 150, 160 on the housing 420) can be reduced (e.g. no unpleasant “clicking” noise is apparent to a user when opening/closing a device, the noise emanating from portions of the cam engagement element 160 striking the housing 420).

Similarly, in some embodiments, the body portion 120 of the first apparatus 100 additionally/alternatively engages with the housing (via an inner surface contact region, such as during movement of the cam), and being made of a dampening material (such as plastic as described), the overall acoustic response characteristics of the housing is altered (i.e. dampened) so that unpleasant noise (such as the striking of the engagement elements 150, 160 on the housing 420) can be reduced (e.g. no unpleasant “clicking” noise is apparent to a user when opening/closing a device, as the housing has been dampened in a manner similar to that of reducing the acoustic output of a cymbal by holding the cymbal during striking).

The provision of a material with a low frictional co-efficient also allows for smooth operation, even though touching contact may be provided.

Similarly, as the body portion 220 of the second apparatus 200 is provided by a dampening material (in this instance one that can be compressed), the unpleasant noise of the cam portion 210 contacting the shaft 490 and/or shaft retainer 495a can be reduced. In this embodiment, the body portion 220 of the second apparatus 200 is maintained in compression in use.

It will readily be appreciated that in alternative embodiments, the body portion 220 of the second apparatus 200 may be comprised with a part 500 of a device, or a portion of a part 500 for a device (e.g. comprised with the casing, or a portion of the casing of a clam-shell mobile device).

Similarly, while the fold hinge assembly has been described with two apparatus 100, 200, in other embodiment, this need not be the case. In some embodiment only one apparatus 100, 200 need be provided. In such instances, an alternative complementary cam arrangement may be provided for the fold hinge assembly 400, in order to engage with the one apparatus 100, 200.

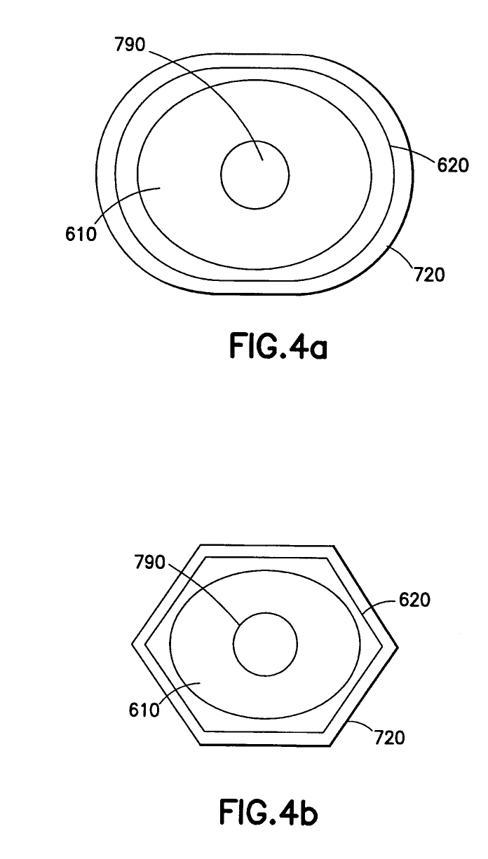

It will also be readily appreciated that the first apparatus 100/fold hinge assembly 400 may not comprise body/cam engagement elements 150, 160. The cross-section of such a configuration is shown in FIG. 4a, showing a housing 720, a shaft 790, a cam contact portion 610, and body portion 620 (cam return spring omitted for clarity). Here the body portion 620 is provided with a cross-section that does not allow for rotation of the body portion 620 relative to a housing 720. The body portion 620, being provided with a larger cross-sectional area than the cam contact portion 610, provides for a fold hinge assembly that, when in use (i.e. being rotated), reduces the amount of unpleasant noise which might emanate from the cam contact portion 610 as a result of the cam contact portion 610 (or feature thereof) contacting the housing In addition, if the cam contact portion 610 does strike the housing 720, the housing 720 (being in mechanical communication, or mechanical communication in use (i.e. only touching during movement) with the body portion 720), dampens any unpleasant sounds. FIG. 4b shows a further embodiment, with like reference numerals.

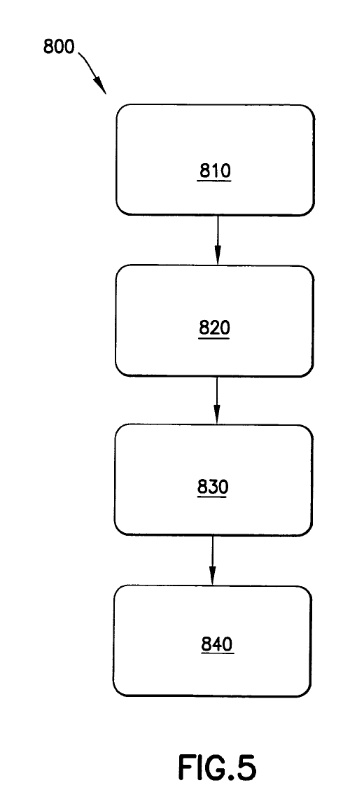

FIG. 5 shows a flowchart of a method of providing 800 an apparatus comprising a cam contact portion and a body portion, wherein there is providing 810 the cam contact portion such that it is in mechanical communication with the body portion. The cam contact portion is configured 820 to allow for camming contact with a complementary cam contact portion. The method further comprises providing 830 the cam contact portion with a contact material for providing wear resistance and providing 840 the body portion with a dampening material for providing dampening and mechanical engagement of the apparatus with a fold hinge assembly, the method for providing an apparatus for a fold hinge assembly for an electronic device.

It will be appreciated that the aforementioned apparatus/elements/assemblies/devices may have other functions in addition to the mentioned functions, and that these functions may be performed by the same apparatus/elements/assemblies/devices

Similar, while in the above embodiments recesses, cut-outs, engaging elements, etc. are described, a skilled reader will appreciate that the invention is not limited to those particular embodiments, and that the recesses, cut-outs protrusions, etc. may be provided in a reciprocal manner where appropriate.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. An apparatus comprising a cam contact portion and a body portion, the cam contact portion configured to be in mechanical communication with the body portion, the cam contact portion configured to allow for camming contact with a complementary cam contact portion, the cam contact portion comprising a contact material for providing wear resistance and the body portion comprising a dampening material for providing dampening and mechanical engagement of the apparatus with a fold hinge assembly for an electronic device.

2. An apparatus according to claim 1, wherein the contact material is a metallic material and the dampening material is a plastic material.

3. An apparatus according to claim 1 wherein the body portion comprises a body engagement element, configured to engage with a complementary element of a fold hinge assembly.

4. An apparatus according to claim 1, wherein a body engagement element of the body portion is configured for engagement with a complementary guide recess/cut-out of a housing for a fold hinge assembly.

5. An apparatus according to claim 4, wherein the guide recess/cut-out and body engagement element are configured to inhibit rotation of the cam contact portion relative to the housing.

6. An apparatus according to claim 1, the apparatus further comprising a housing, the housing configured to allow for transfer of a rotational camming action of the cam contact portion to a part for an electronic device.

7. An apparatus according to claim 6, wherein at least one body engagement element is configured to interfere with at least one recess/cut-out during rotational movement of the housing such that it allows for linear movement of the cam contact portion relative to the major axis of the housing, but does not allow for rotational movement of the cam contact portion/body portion relative to the housing.

8. An apparatus according to claim 1, wherein the body portion is configured to engage with a housing for the apparatus.

9. An apparatus according to claim 8, wherein the body portion is configured to provide an interference engagement with a housing for the apparatus.

10. An apparatus according to claim 1, wherein the body portion is configured for interference engagement with a fold hinge assembly for an electronic device.

11. An apparatus according to claim 10, wherein the body portion is configured for interference engagement with a retaining element of a fold hinge assembly.

12. An apparatus according to claim 11, wherein the body portion is comprised with a part for an electronic device.

13. A module comprising at least one apparatus according to claim 1, the module further comprising at least one of: a shaft; a cam return spring; a housing.

14. A fold hinge for an electronic device comprising a module according to claim 13.

15. A module for an electronic device comprising a fold hinge according to claim 14.

16. A module according to claim 15, further comprising a rotatable part for an electronic device.

17. An electronic device comprising a module according to claim 15, the electronic device may be one of: mobile telephone; media device; multimedia device; Personal Digital Assistant, portable computer; gaming device.

18. A means for an apparatus comprising a means for a cam contact and a means for a body, the means for cam contact configured to be in mechanical communication with the means for a body, the means for cam contact configured to allow for camming contact with a complementary means for cam contact, the means for cam contact comprising a means for a contact material for providing wear resistance and the means for a body comprising a means for a dampening material for providing dampening and mechanical engagement of the means for an apparatus with a means for a fold hinge assembly for an electronic device.

19. A method comprising:
providing an apparatus comprising a cam contact portion and a body portion;
providing the cam contact portion such that it is configured to be in mechanical communication with the body portion;
configuring the cam contact portion to allow for camming contact with a complementary cam contact portion;
providing the cam contact portion with a contact material for providing wear resistance; and
providing the body portion with a dampening material for providing dampening and mechanical engagement of the apparatus with a fold hinge assembly, the method for providing an apparatus for a fold hinge assembly for an electronic device.

20. Use of an apparatus according to claim 1.

21. An apparatus comprising a cam contact portion and a body portion, the cam contact portion configured to be in mechanical communication with the body portion, the cam contact portion configured to allow for camming contact with a complementary cam contact portion, the cam contact portion comprising a metallic contact material for providing wear resistance and the body portion comprising a plastic dampening material for providing dampening and mechanical engagement of the apparatus with a fold hinge assembly for an electronic device.

22. An electronic device comprising a module according to claim 16, the electronic device may be one of: mobile telephone; media device; multimedia device; Personal Digital Assistant, portable computer; gaming device.
